(19) United States
(12) Patent Application Publication
(10) Pub. No.: US 2025/0388256 A1
(43) Pub. Date: Dec. 25, 2025

(54) STEERING FEEDBACK ACTUATOR

(71) Applicant: HYUNDAI MOBIS CO., LTD., Seoul (KR)

(72) Inventors: Il Ryong KIM, Yongin-si (KR); Jae Won CHOI, Yongin-si (KR)

(73) Assignee: HYUNDAI MOBIS CO., LTD., Seoul (KR)

(21) Appl. No.: 19/047,838

(22) Filed: Feb. 7, 2025

(30) Foreign Application Priority Data
Jun. 19, 2024 (KR) 10-2024-0079712

(51) Int. Cl. B62D 5/00

(52) U.S. Cl. CPC B62D 5/006

(57) ABSTRACT

The steering feedback actuator includes a housing, a cover disposed to face the housing, a motor disposed within the housing, a sun gear connected to the motor, a ring gear disposed to surround the sun gear, a planet gear disposed between the sun gear and the ring gear, a carrier connected to the planet gear and rotated in conjunction with a rotation of the planet gear, and a fixing member provided between the cover and the ring gear and configured to fix the cover to the ring gear.

### CROSS-REFERENCE TO RELATED APPLICATION

This application claims priority from and the benefit of Korean Patent Application No. 10-2024-0079712, filed on Jun. 19, 2024, which is hereby incorporated by reference for all purposes as if set forth herein.

### BACKGROUND

### Field

Exemplary embodiments of the present disclosure relate to a steering feedback actuator, and more particularly, to a steering feedback actuator which provides feedback to a steering wheel in a steer-by-wire (SBW) system.

### Discussion of the Background

A conventional power steering system for a vehicle is a fluid pressure type steering system that generates fluid pressure by using an oil pump that is driven by the power of an engine and generates steering assistance power by using the fluid pressure. Such a fluid pressure type steering system has disadvantages in that the pressure type steering system requires multiple parts and has a complicated structure. For this reason, an SBW system that transfers a driver's steering intention to a vehicle wheel through an electric signal without a mechanical connection between a steering wheel and the vehicle wheel is researched and developed. The SBW system can improve driving convenience and vehicle stability because it is easy to change a steering ratio depending on the driving conditions of a vehicle.

The SBW system may include a steering feedback actuator (SFA) and a road wheel actuator (RWA). The SFA provides feedback to a steering wheel so that a driver can feel the weight of the steering wheel when rotating and manipulating the steering wheel. Such feedback may be generated and provided by a feedback motor that is connected to the steering wheel.

The Background Technology of the present disclosure is disclosed in Korean Patent No. 10-0530034 (Nov. 14, 2005) entitled “STEERING REPULSIVE POWER CONTROL APPARATUS OFSTEER-BY-WIRE SYSTEM WHICH CONTROLLING FOR REPULSIVEPOWER TORQUE BY WIDTH ACCELERATION”.

### SUMMARY

Various embodiments are directed to providing a steering feedback actuator capable of implementing the reduction of a size and a high deceleration ratio.

In an embodiment, a steering feedback actuator may include a housing, a cover disposed to face the housing, a motor disposed within the housing, a sun gear connected to the motor, a ring gear disposed to surround the sun gear, a planet gear disposed between the sun gear and the ring gear, a carrier connected to the planet gear and rotated in conjunction with a rotation of the planet gear, and a fixing member provided between the cover and the ring gear and configured to fix the cover to the ring gear.

The housing may include a housing body, a first accommodation part disposed within the housing body and configured to accommodate the motor, a second accommodation part disposed between the first accommodation part and the cover and configured to accommodate the ring gear, and a barrier rib disposed between the first accommodation part and the second accommodation part.

The planet gear may include a first planet gear body engaged with the sun gear and a second planet gear body configured to extend from the first planet gear body and engaged with the ring gear.

The diameter of the second planet gear body may be smaller than the diameter of the first planet gear body.

The carrier may include a carrier body disposed to face the planet gear and configured to penetrate the cover and a transfer shaft coupled with the carrier body and configured to extend to an outside of the cover.

The fixing member may include a guide rail concavely formed into an inside of any one of the cover and the ring gear and a guide pin configured to protrude from the other of the cover and the ring gear and inserted into the guide rail.

The cover and the ring gear may be disposed to face each other in a first direction. The guide rail may include a first guide rail configured to extend in the first direction and a second guide rail configured to extend in a second direction that intersects the first direction from the first guide rail.

An interval between the cover and the ring gear may be reduced as the guide pin is moved from the first guide rail toward the second guide rail.

The fixing member may further include a first wedge part configured to protrude from the cover toward the ring gear and a second wedge part configured to protrude from the ring gear toward the cover, to come into contact with the first wedge part, and to restrict the guide pin from being moved in a direction opposite to the second direction.

The first wedge part and the second wedge part may be elastically deformable.

The first wedge part may be provided in a plural number. The plurality of first wedge parts may be arranged in a circumferential direction centered around the central axis of the cover.

The first wedge part may include a first slope disposed to be inclined with respect to the first direction and a first trapping surface configured to extend from the first slope toward the cover and disposed in parallel to the first direction. The second wedge part may include a second slope disposed in parallel to the first slope and configured to come into contact with the first slope and a second trapping surface configured to extend from the second slope toward the ring gear and disposed in parallel to the first direction.

The second wedge part may further include a groove concavely formed from the second trapping surface.

The fixing member may include a retainer body fixed within the ring gear, an extension part configured to extend from the retainer body and to penetrate the cover, and a caulking part disposed at an end of the extension part and configured to support the ring gear with respect to the cover.

A cross sectional area of the caulking part may be greater than a cross sectional area of the extension part.

According to embodiments of the present disclosure, interference between the motor and the deceleration member can be prevented and damage to the motor attributable to grease or an alien substance can be prevented because the deceleration member and the motor are disposed in the spaces that are separated from each other within the housing.

According to the embodiments of the present disclosure, the deceleration ratio of the deceleration member can be further increased within a limited space because the first planet gear body and the second planet gear body having different diameters are engaged and coupled with the sun gear and the ring gear, respectively.

According to the embodiments of the present disclosure, since the ring gear is fixed to the cover by the fixing member, a degree of the deformation of the ring gear can be relatively reduced compared to a case in which the ring gear is press-fitted and fixed to the housing, and the generation of noise and the weakening of durability attributable to the deformation of the ring gear can be prevented.

According to the embodiments of the present disclosure, an assembly process can be reduced and costs for fabrication can be reduced because the guide rail and the guide pin can fix the ring gear to the cover by only a relative movement of the cover and the ring gear.

According to the embodiments of the present disclosure, the cover and the ring gear can be prevented from being arbitrarily separated by external vibration or an external force because a movement of each of the first wedge part and the second wedge part in the second direction of the guide pin is restricted.

### BRIEF DESCRIPTION OF THE DRAWINGS

FIG. 1 is a diagram schematically illustrating a construction of a steering apparatus including a steering feedback actuator (SFA) according to an embodiment of the present disclosure.

FIG. 2 is a perspective view schematically illustrating a construction of the SFA according to an embodiment of the present disclosure.

FIG. 3 is an exploded perspective view schematically illustrating a construction of the SFA according to an embodiment of the present disclosure.

FIG. 4 is a cross-sectional view schematically illustrating a construction of the SFA according to an embodiment of the present disclosure.

FIG. 5 is a cross-sectional perspective view schematically illustrating a construction of a cover according to an embodiment of the present disclosure.

FIG. 6 is a perspective view schematically illustrating a construction of a ring gear according to an embodiment of the present disclosure.

FIG. 7 is a cross-sectional perspective view schematically illustrating a construction of the ring gear according to an embodiment of the present disclosure.

FIG. 8 is a diagram schematically illustrating a construction of a planet gear according to an embodiment of the present disclosure.

FIG. 9 is a diagram schematically illustrating a construction of a first wedge part and a second wedge part according to an embodiment of the present disclosure.

FIGS. 10 to 15 are diagrams schematically illustrating a process of assembling the SFA according to an embodiment of the present disclosure.

FIG. 16 is a diagram schematically illustrating a construction of a fixing member according to another embodiment of the present disclosure.

FIGS. 17 and 18 are diagrams schematically illustrating a process of forming a caulking part according to the present embodiment.

### DETAILED DESCRIPTION OF THE ILLUSTRATED EMBODIMENTS

Hereinafter, a steering feedback actuator (SFA) according to embodiments of the present disclosure is described with reference to the accompanying drawings.

In this process, the thicknesses of lines or the sizes of components illustrated in the drawings may have been exaggerated for the clarity of a description and for convenience' sake. Terms to be described below have been defined by taking into consideration their functions in the present disclosure, and may be changed depending on a passenger or operator's intention or practice. Accordingly, such terms should be defined based on the overall contents of this specification.

Furthermore, throughout the specification, when it is described that one part is “connected (or coupled)” to another part, the one part may be “directly connected (or coupled)” to the another part or may be “indirectly connected (or coupled)” to the another part with another member interposed therebetween. When it is said that one component “includes (or comprises)” the other component, this means that the one component may further “include (or comprise)” another component not the exclusion of another component unless explicitly described to the contrary.

Furthermore, throughout this specification, the same reference numerals may denote the same components. Although not mentioned or described in a specific drawing, the same reference numerals or similar reference numerals may be described on the basis of another drawing. Furthermore, although a reference numeral is not indicated in a portion of a specific drawing, the portion may be described on the basis of another drawing. Furthermore, the number, shapes, and sizes of detailed components included in the drawings of this application, a relative difference between the sizes, etc. have been set for convenience of understanding, and do not limit embodiments, and may be implemented in various forms.

Hereinafter, in describing the present disclosure with a plurality of embodiment, a redundant description of components that are identical with each other or correspond to each other in the plurality of embodiments is omitted. For example, if a component that is the same as or corresponds to a component disclosed in any one embodiment is disclosed in another embodiment, a description of the corresponding component is omitted in another embodiment, and a component having a difference is mainly described.

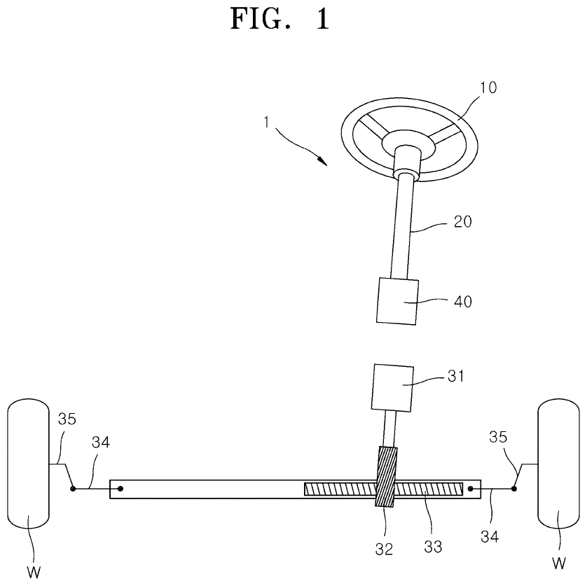

FIG. 1 is a diagram schematically illustrating a construction of a steering apparatus including a steering feedback actuator (SFA) according to an embodiment of the present disclosure.

Referring to FIG. 1, the steering apparatus according to the present embodiment may include a steering wheel 10 that is rotated by a driver's manipulation, a steering shaft 20 connected to the steering wheel 10, a steering actuator 31 that is spaced apart from the steering shaft 20 and that adjusts the steering angle of a wheel W, and a steering feedback actuator (SFA) 40 that is connected to the steering shaft 20 and that applies feedback to the steering shaft 20 in a direction opposite to the manipulation direction of the steering wheel 10.

The steering actuator 31 may adjust the steering angle of the wheel W based on data that are detected by a steering input sensor (not illustrated) that detects steering input information including at least one of the rotation angle and torque of the steering shaft 20.

The steering input sensor may include various types of sensing devices capable of detecting at least one of the rotation angle and torque of the steering shaft 20, such as an angle sensor and a torque sensor.

The steering actuator 31 may include a steering motor that rotates a pinion shaft 32 by power received from the outside. The steering actuator 31 may perform the steering of the wheel W through a tie rod 34 and a knuckle arm 35 by slidingly moving a rack bar 33 connected to the pinion shaft 32.

The SFA 40 may apply feedback to the steering shaft 20 based on data that are detected by a steering output sensor (not illustrated) that detects steering output information including at least one of the rotation angle of the wheel W and the location of the rack bar 33. The steering output sensor may include various types of sensing devices capable of detecting at least one of the rotation angle of the wheel W and the location of the rack bar 33, such as an angle sensor, a location sensor, radar, a camera, and an image sensor.

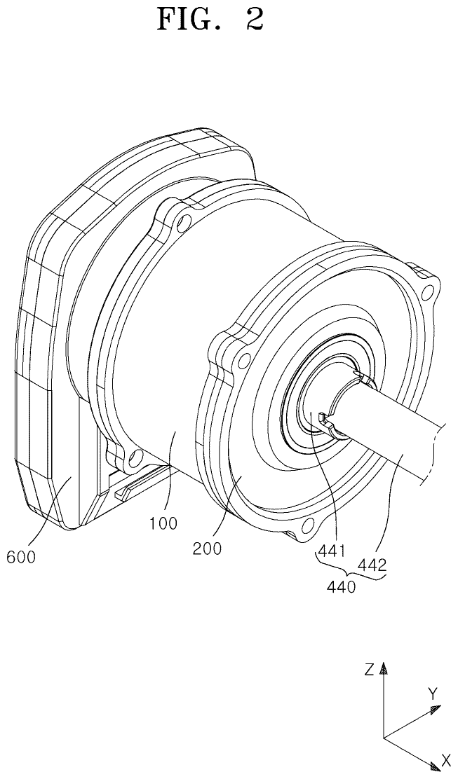

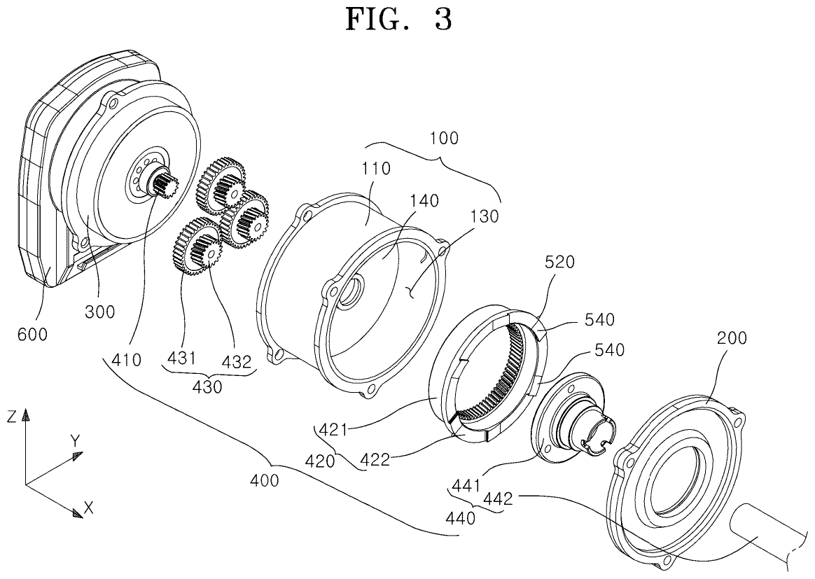

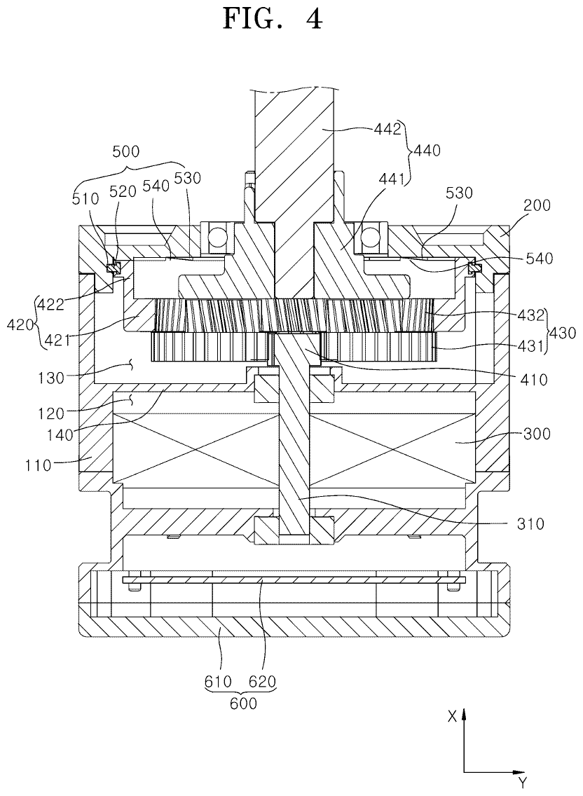

FIG. 2 is a perspective view schematically illustrating a construction of the SFA according to an embodiment of the present disclosure. FIG. 3 is an exploded perspective view schematically illustrating a construction of the SFA according to an embodiment of the present disclosure. FIG. 4 is a cross-sectional view schematically illustrating a construction of the SFA according to an embodiment of the present disclosure.

Referring to FIGS. 1 to 4, the SFA 40 according to the present embodiment includes a housing 100, a cover 200, a motor 300, a deceleration member 400, and a fixing member 500.

The housing 100 forms a schematic appearance of the SFA 40, and may generally support the cover 200, the motor 300, the deceleration member 400, and the fixing member 500.

The housing 100 according to the present embodiment may include a housing body 110, a first accommodation part 120, a second accommodation part 130, and a barrier rib 140.

The housing body 110 may be formed to have a form of a cylinder having an inside emptied. The central axis of the housing body 110 may be disposed in parallel to a first direction. An example in which the first direction described hereinafter is a direction that is directed from the bottom to the top in a direction parallel to an X axis on the basis of FIG. 4 is described. Both ends of the housing body 110 that are perpendicular to the first direction may be formed to be opened.

The first accommodation part 120 and the second accommodation part 130 may be disposed within the housing body 110. The first accommodation part 120 and the second accommodation part 130 may function as components that provide spaces in which the motor 300 and the deceleration member 400 are accommodated within the housing body 110.

The first accommodation part 120 and the second accommodation part 130 according to the present embodiment may refer to some spaces that belong to the entire internal space of the housing body 110 and that are disposed to face each other in the first direction. The first accommodation part 120 and the second accommodation part 130 may communicate with the external space of the housing body 110 through both ends of the housing body 110 that are opened. In the present embodiment, the first accommodation part 120 and the second accommodation part 130 may be sequentially disposed in the first direction. That is, the second accommodation part 130 may be disposed at a location that is spaced apart from the first accommodation part 120 at a predetermined interval in the first direction. A cross-sectional shape of each of the first accommodation part 120 and the second accommodation part 130 that are perpendicular to the first direction may be designed and changed in various shapes, such as an oval and a polygon, in addition to a circle.

The barrier rib 140 may be disposed between the first accommodation part 120 and the second accommodation part 130. The barrier rib 140 may function as a component that mutually partitions the first accommodation part 120 and the second accommodation part 130 within the housing body 110.

The barrier rib 140 according to the present embodiment may have an approximately circular plate form. The central axis of the barrier rib 140 may be disposed on the same axis as the central axis of the housing body 110. An outer circumferential surface of the barrier rib 140 may be integrally formed with an inner circumferential surface of the housing body 110, or may be coupled with the inner circumferential surface of the housing body 110 by welding or fitting coupling. Both surfaces of the barrier rib 140 that are perpendicular to the first direction may be disposed toward the first accommodation part 120 and the second accommodation part 130, respectively.

The cover 200 may be disposed to face the housing 100, and may seal the internal space of the housing 100. The cover 200 may be disposed to face the second accommodation part 130 in the first direction.

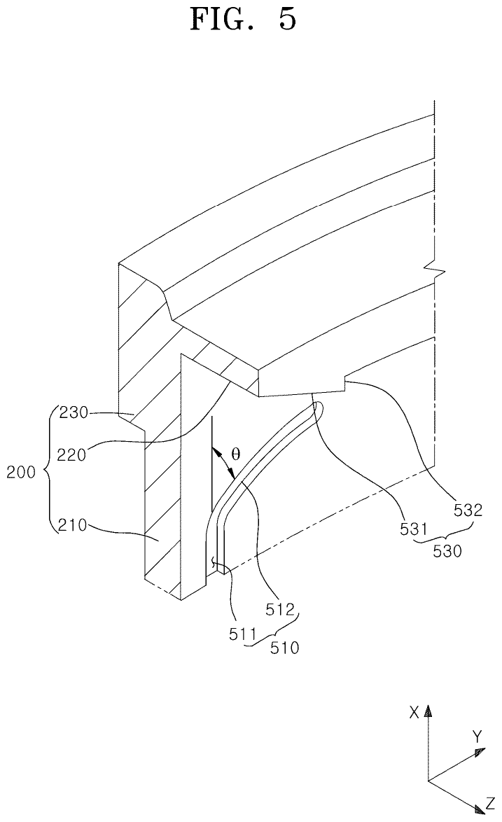

FIG. 5 is a cross-sectional perspective view schematically illustrating a construction of the cover according to an embodiment of the present disclosure.

Referring to FIGS. 2 to 5, the cover 200 according to the present embodiment may include a first cover body 210 and a second cover body 220.

The first cover body 210 may be disposed within the housing 100.

The first cover body 210 according to the present embodiment may have a form of a cylinder having an inside emptied and both sides opened. The outside diameter of the first cover body 210 may be smaller than the inside diameter of the housing body 110 or may be the same as the inside diameter of the housing body 110. The central axis of the first cover body 210 may be disposed on the same axis as the central axis of the housing body 110. The first cover body 210 may be disposed within the housing body 110, more specifically, the second accommodation part 130. The first cover body 210 may be inserted into the second accommodation part 130 by being moved in a direction opposite to the first direction from the outside of the housing body 110 toward the housing body 110. In another embodiment, the first cover body 210 may be inserted into the second accommodation part 130 as the housing body 110 is moved toward the first cover body 210 in the first direction.

The second cover body 220 extends from the first cover body 210, and may seal the housing 100.

The second cover body 220 according to the present embodiment may have a form of a circular plate that is disposed within the first cover body 210. An outer circumferential surface of the second cover body 220 may be integrally formed with an inner circumferential surface of the first cover body 210, and may be coupled with the inner circumferential surface of the first cover body 210 by welding or fitting coupling. The central axis of the second cover body 220 may be disposed on the same axis as the central axis of the first cover body 210. One surface of the second cover body 220 that is perpendicular to the first direction may be disposed to face the second accommodation part 130 in the first direction. The other surface of the second cover body 220 that is perpendicular to the first direction may be disposed toward the external space of the first cover body 210.

The cover 200 according to the present embodiment may further include a support part 230.

The support part 230 extends from the first cover body 210, and may come into contact with the housing 100.

The support part 230 according to the present embodiment may extend toward the outside of the first cover body 210 in the radial direction of the first cover body 210 from an outer circumferential surface of the first cover body 210. The support part 230 may have a form of a ring that surrounds the outer circumferential surface of the first cover body 210. The support part 230 may come into contact with an end surface of the housing body 110 that is disposed to surround the second accommodation part 130, as the first cover body 210 is inserted into the second accommodation part 130 at a set distance or more. The support part 230 may be fixed to the housing body 110 by various types of coupling methods, such as welding, bolting, and fitting coupling.

The motor 300 is disposed within the housing 100, and may generate a driving force for driving the SFA 40.

The motor 300 according to the present embodiment may be exemplified as various types of electric motors each of which is constructed to include a stator (not illustrated) and a rotor (not illustrated) that is rotated by a magnetic field generated by the stator and that can generate torque. The motor 300 may be disposed within the first accommodation part 120. The motor 300 may be fixed to the inner side of the housing body 110 that surrounds the first accommodation part 120 or one surface of the barrier rib 140 that faces the first accommodation part 120.

The motor 300 may include an output shaft 310 that is connected to the rotor.

The output shaft 310 according to the present embodiment may have a form or a rod having a length direction disposed in parallel to the first direction. The central axis of the output shaft 310 may be disposed on the same axis as the central axis of the housing body 110. One side of the output shaft 310 may be connected to the rotor. The other side of the output shaft 310 may protrude into the second accommodation part 130 through the barrier rib 140. The output shaft 310 may be rotatably supported with respect to the barrier rib 140 by a bearing. When the motor 300 is driven, the output shaft 310 may be rotated around the central axis clockwise or counterclockwise.

The deceleration member 400 is disposed within the housing 100, and may be connected to the motor 300. The deceleration member 400 may function as a component that transfers, to the steering shaft 20, torque that is generated by the motor 300.

The deceleration member 400 may be disposed within the second accommodation part 130. Accordingly, the SFA 40 according to the present embodiment can prevent interference between the motor 300 and the deceleration member 400, and can prevent grease of the deceleration member 400 from entering the motor 300.

The deceleration member 400 according to the present embodiment may include a sun gear 410, a ring gear 420, a planet gear 430, and a carrier 440.

The sun gear 410 may be connected to the motor 300.

The sun gear 410 according to the present embodiment may have a form of a cylindrical spur gear or pinion gear having gear teeth formed on an outer circumferential surface thereof. The sun gear 410 may be connected to the other side of the output shaft 310 of the motor 300, which protrudes into the second accommodation part 130. The central axis of the sun gear 410 is parallel to the first direction, and may be disposed on the same axis as the central axis of the output shaft 310. The sun gear 410 may be integrally formed with the output shaft 310 of the motor 300, and may be coupled with the output shaft of the motor 300 by welding or spline coupling.

The ring gear 420 is spaced apart from the sun gear 410, and may be disposed to surround the sun gear 410. The ring gear 420 may be fixed to the cover 200 by the fixing member 500. The ring gear 420 may be made of a plastic material. Accordingly, the ring gear 420 can reduce overall weight of the SFA 40, and can lower costs for fabrication.

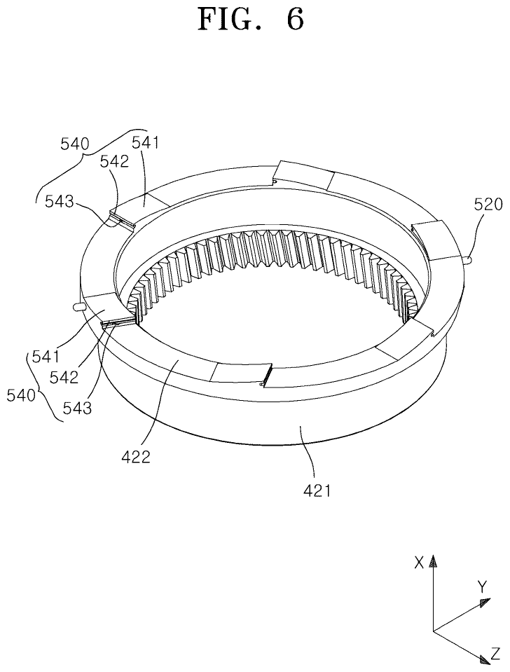

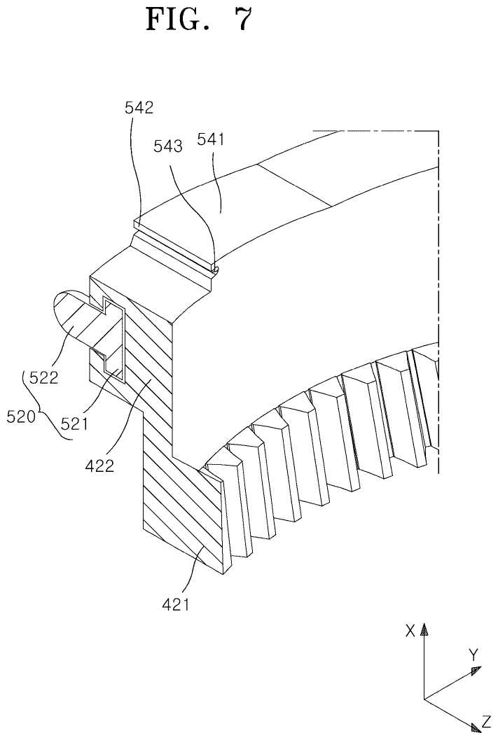

FIG. 6 is a perspective view schematically illustrating a construction of the ring gear according to an embodiment of the present disclosure. FIG. 7 is a cross-sectional perspective view schematically illustrating a construction of the ring gear according to an embodiment of the present disclosure.

Referring to FIGS. 6 and 7, the ring gear 420 according to the present embodiment may include a ring gear body 421 and a flange 422.

The ring gear body 421 according to the present embodiment may have a form of a cylinder having an inside emptied and both sides opened. The outside diameter of the ring gear body 421 may be smaller than the inside diameter of the housing body 110. The ring gear body 421 may be disposed within the second accommodation part 130. The central axis of the ring gear body 421 may be disposed on the same axis as the central axis of the housing body 110. Gear teeth that are engaged with the planet gear 430 may be formed on an inner circumferential surface of the ring gear body 421. An outer circumferential surface of the ring gear body 421 may be spaced apart from the inner circumferential surface of the housing body 110 at a predetermined interval. Accordingly, the ring gear body 421 can prevent the generation of noise and damage attributable to a collision against the housing body 110.

The flange 422 according to the present embodiment may have a form of a ring having a hollow formed at a central part thereof. The flange 422 may be integrally formed with one end of the ring gear body 421 that is disposed to face the cover 200, among both ends of the ring gear body 421. In another embodiment, the flange 422 may be coupled with one end of the ring gear body 421 by welding, bolting, or fitting coupling. An outer circumferential surface of the flange 422 may be disposed to face the inner circumferential surface of the first cover body 210 in the radial direction of the housing body 110. One surface (i.e., an upper surface on the basis of FIGS. 4 and 6) of the flange 422 that is disposed toward the cover 200 may be disposed to face one surface (i.e., a lower surface on the basis of FIGS. 4 and 5) of the second cover body 220, which faces the second accommodation part 130, in the first direction.

The planet gear 430 is disposed within the second accommodation part 130, and may be disposed between the sun gear 410 and the ring gear 420. The planet gear 430 may be engaged and coupled with the sun gear 410 and the ring gear 420. The central axis of the planet gear 430 may be disposed in parallel to the first direction. The planet gear 430 may rotate around the central axis by torque received from the sun gear 410 when the sun gear 410 is rotated. As the ring gear 420 is fixed to the cover 200 by the fixing member 500, the planet gear 430 may revolve around the sun gear 410 between the sun gear 410 and the ring gear 420 when the sun gear 410 is rotated.

The planet gear 430 may be provided in a plural number. The plurality of planet gears 430 may be arranged at predetermined intervals in a circumferential direction thereof centering around the central axis of the sun gear 410. An example in which three planet gears 430 are formed is illustrated in FIG. 3, but the number of planet gears 430 is not limited thereto and may be designed and changed in various numbers, such as two and four.

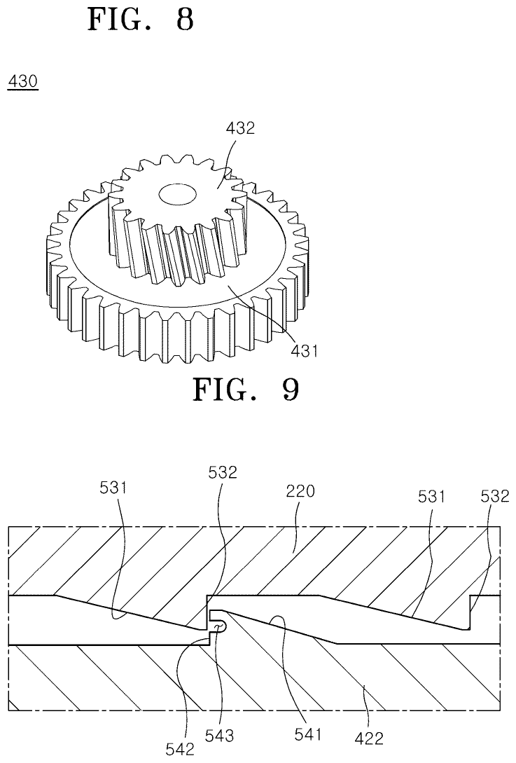

FIG. 8 is a diagram schematically illustrating a construction of the planet gear according to an embodiment of the present disclosure.

Referring to FIGS. 2 to 8, the planet gear 430 according to the present embodiment may include a first planet gear body 431 and a second planet gear body 432.

The first planet gear body 431 forms an appearance of the planet gear 430 on one side thereof, and may be engaged with the sun gear 410.

The first planet gear body 431 according to the present embodiment may have a form of a cylindrical spur gear or pinion gear having gear teeth formed on an outer circumferential surface thereof. The central axis of the first planet gear body 431 may be disposed in parallel to the first direction.

The outer circumferential surface of the first planet gear body 431 may be engaged and coupled with the outer circumferential surface of the sun gear 410. Accordingly, the first planet gear body 431 may rotate around the central axis by torque received from the sun gear 410 when the sun gear 410 is rotated.

The second planet gear body 432 forms an appearance of the planet gear 430 on the other side thereof, and may be engaged with the ring gear 420.

The second planet gear body 432 according to the present embodiment may extend from the first planet gear body 431 in the first direction. The second planet gear body 432 may have a form of a cylindrical spur gear or pinion gear having gear teeth formed on an outer circumferential surface thereof. The central axis of the first planet gear body 431 may be disposed on the same axis as the central axis of the first planet gear body 431. The second planet gear body 432 may be integrally formed with the first planet gear body 431, and may be coupled with the first planet gear body 431 after manufactured separately from the first planet gear body 431.

The outer circumferential surface of the second planet gear body 432 may be engaged and coupled with the ring gear 420, more specifically, the inner circumferential surface of the ring gear body 421. As the ring gear 420 is fixed to the cover 200 by the fixing member 500, the second planet gear body 432 may revolve on the circumference centered around the sun gear 410 along with the first planet gear body 431 when the sun gear 410 is rotated.

The diameter of the second planet gear body 432 may be different from the diameter of the first planet gear body 431. For example, the diameter of the second planet gear body 432 may be smaller than the diameter of the first planet gear body 431. The number of gear teeth formed on the outer circumferential surface of the second planet gear body 432 may be smaller than the number of gear teeth of the first planet gear body 431. Accordingly, the planet gear 430 can implement a high deceleration ratio by relatively increasing a deceleration ratio by the ratio of the number of gear teeth of the first planet gear body 431 to the number of gear teeth formed on the outer circumferential surface of the second planet gear body 432.

The carrier 440 is connected to the planet gear 430, and may be rotated in conjunction with the rotation of the planet gear 430. The carrier 440 may function as a component that finally transfers, to the steering shaft 20, torque that is generated by the motor 300.

The carrier 440 according to the present embodiment may include a carrier body 441 and a transfer shaft 442.

The carrier body 441 is disposed to face the planet gear 430, and may penetrate the cover 200. The carrier body 441 may be connected to the planet gear 430. The carrier body 441 may be rotated around its central axis when the planet gear 430 performs an orbit motion. Accordingly, when the motor 300 operates, torque generated by the motor 300 may be transferred to the carrier body 441 sequentially through the sun gear 410 and the planet gear 430.

The carrier body 441 according to the present embodiment may be disposed to face the planet gear 430 in the first direction. The central axis of the carrier body 441 may be disposed on the same axis as the central axis of the housing body 110.

One side (i.e., the top on the basis of FIG. 4) of the carrier body 441 may penetrate the second cover body 220 of the cover 200. One side of the carrier body 441 may be supported to the second cover body 220 by a bearing centering in a way to rotate around the central axis.

The other side (i.e., the bottom on the basis of FIG. 4) of the carrier body 441 may be connected to the planet gear 430 by a support pin (not illustrated) that penetrates the central part of the planet gear 430. The other side of the carrier body 441 may be individually connected to the plurality of planet gears 430.

The transfer shaft 442 is coupled with the carrier body 441, and may extend toward the outside of the cover 200.

The transfer shaft 442 according to the present embodiment may be connected to one side of the carrier body 441 that penetrates the second cover body 220. The central axis of the transfer shaft 442 may be disposed on the same axis as the central axis of the carrier body 441. The transfer shaft 442 may be integrally formed with the carrier body 441. In another embodiment, the transfer shaft 442 may be coupled with the carrier body 441 by various types of coupling methods, such as welding, bolting, and spline coupling. The transfer shaft 442 may be rotated around the central axis along with the carrier body 441 when the carrier body 441 is rotated.

An end of the transfer shaft 442 may extend toward the outside of the second cover body 220. The end of the transfer shaft 442 may be connected to the steering shaft 20. The end of the transfer shaft 442 may be directly connected to the steering shaft 20. In another embodiment, the end of the transfer shaft 442 may be directly connected to the steering shaft 20 by various types of connection means (not illustrated), such as a gear and a pulley.

The fixing member 500 may be provided between the cover 200 and the ring gear 420. The fixing member 500 may function as a component that fixes the ring gear 420 to the cover 200. Accordingly, the SFA 40 according to the present embodiment can relatively reduce a degree of deformation of the ring gear 420 compared to a case in which the ring gear 420 is press-fitted into the housing body 110, and can prevent the generation of noise and the weakening of durability attributable to the deformation of the ring gear 420.

The fixing member 500 according to the present embodiment may include a guide rail 510 and a guide pin 520. Hereinafter, an example in which the guide rail 510 is formed in the cover 200 and the guide pin 520 is formed in the ring gear 420 is described, but the present disclosure is not limited thereto. The guide rail 510 may be formed in the ring gear 420 or the guide pin 520 may be formed in the cover 200.

The guide rail 510 may function as a component that provides guidance to a movement of the guide pin 520 when the cover 200 and the ring gear 420 are assembled.

The guide rail 510 according to the present embodiment may have a form of a groove that is concavely formed from the cover 200, more specifically, the inner circumferential surface of the first cover body 210 toward the outer circumferential surface of the first cover body 210. The guide rail 510 may be provided in a plural number. The plurality of guide rails 510 may be arranged at predetermined intervals in a circumferential direction thereof centering around the central axis of the first cover body 210.

The guide rail 510 according to the present embodiment may include a first guide rail 511 and a second guide rail 512.

The first guide rail 511 may be some section of the guide rail 510, which belongs to the entire section of the guide rail 510 and extends in the first direction. One end (i.e., the bottom on the basis of FIG. 5) of the first guide rail 511 may penetrate one end (i.e., the bottom on the basis of FIG. 5) of the first cover body 210 that is disposed toward the barrier rib 140 within the second accommodation part 130.

The second guide rail 512 may be the remaining section of the entire section of the guide rail 510 except the first guide rail 511. The second guide rail 512 may extend from the first guide rail 511 in a second direction that intersects the first direction. In the present embodiment, the second direction may be exemplified as a direction that is inclined from the first direction toward a YZ plane at a set angle θ as illustrated in FIG. 5 and extends clockwise along the inner circumferential surface of the first cover body 210 centering around the central axis of the first cover body 210.

The guide pin 520 is inserted into the guide rail 510 when the cover 200 and the ring gear 420 are assembled, and may function as a component that mechanically supports the ring gear 420 with respect to the cover 200.

The guide pin 520 is moved along the guide rail 510, and may adjust an interval between the cover 200 and the ring gear 420. For example, as the guide pin 520 is moved from the first guide rail 511 toward the second guide rail 512, the interval between the cover 200 and the ring gear 420, which are parallel to the first direction, may be gradually reduced. More specifically, when the guide pin 520 is moved along the first guide rail 511 in the first direction, any one of the cover 200 or the ring gear 420 may be moved toward the other of the cover 200 or the ring gear 420 in a direction parallel to the first direction. When the guide pin 520 is moved along the second guide rail 512 in the second direction, any one of the cover 200 or the ring gear 420 may be relatively rotated with respect to the other of the cover 200 or the ring gear 420 centering around the central axis of the housing body 110, and may be moved toward the other of the cover 200 or the ring gear 420.

When the guide pin 520 is disposed at the end of the second guide rail 512, the support part 230 may come into contact with the end surface of the housing body 110 that is disposed to surround the second accommodation part 130.

The guide pin 520 may be made of the same material as the ring gear 420. In another embodiment, the guide pin 520 may be made of a material different from that of the ring gear 420, for example, a metal material.

The guide pin 520 may be provided in a plural number. The number of plurality of the guide pins 520 may be the same as the number of guide rails 510. The guide pins 520 may be individually inserted into different guide rails 510 in a process of assembling the cover 200 and the ring gear 420.

The guide pin 520 according to the present embodiment may include a pin body 521 and a protrusion part 522.

The pin body 521 is disposed within the ring gear 420, and may support the protrusion part 522.

The pin body 521 according to the present embodiment may be disposed within the flange 422. The pin body 521 may be integrally formed with the flange 422 by insert injection, and may be fixed within the flange 422 by an adhesive or press-fitting.

The protrusion part 522 extends from the pin body 521, and may be inserted into the guide rail 510.

The protrusion part 522 according to the present embodiment may have a form of a rod that extends in the radial direction of the ring gear 420 from the pin body 521. The protrusion part 522 may penetrate an outer circumferential surface of the flange 422 and protrude to the outside of the flange 422. A length in which the protrusion part 522 is extended may be variously designed and changed within the range of a length in which the protrusion part 522 may be inserted into the guide rail 510. The end of the protrusion part 522 may be rounded and formed at predetermined curvature. Accordingly, the protrusion part 522 may be smoothly inserted into the guide rail 510.

The fixing member 500 according to the present embodiment may further include a first wedge part 530 and a second wedge part 540.

The first wedge part 530 and the second wedge part 540 may each function as a component that allows the guide pin 520, more specifically, the protrusion part 522 to move in the second direction within the second guide rail 512 and that restricts the protrusion part 522 from being moved in a direction opposite to the second direction. Accordingly, the first wedge part 530 and the second wedge part 540 can prevent the protrusion part 522 from being moved in the direction opposite to the second direction and the cover 200 and the ring gear 420 from being arbitrarily separated from each other due to external vibration or an external force.

The first wedge part 530 may protrude in the direction opposite to the first direction from the cover 200 toward the ring gear 420.

The first wedge part 530 may be provided in a plural number. The plurality of first wedge parts 530 may be arranged at predetermined intervals in a circumferential direction centering around the central axis of the cover 200.

FIG. 9 is a diagram schematically illustrating a construction of the first wedge part and the second wedge part according to an embodiment of the present disclosure.

Referring to FIGS. 2 to 9, the first wedge part 530 according to the present embodiment may include a first slope 531 and a first trapping surface 532.

The first slope 531 may be disposed to be inclined with respect to the first direction.

The first slope 531 according to the present embodiment may slantly extend at a predetermined angle to the first direction from one surface (i.e., a lower surface on the basis of FIGS. 5 and 9) of the second cover body 220 that faces the ring gear 420 in the first direction toward the flange 422. FIGS. 5 and 9 illustrate an example in which the first slope 531 extends in a direction in which the first slope 531 protrudes toward the flange 422 as the first slope 531 is more directed toward the right or clockwise direction, but the direction in which the first slope 531 extends is not limited thereto and may be variously designed and changed depending on a shape of the guide rail 510 and the direction in which the guide rail 510 extends.

The first trapping surface 532 may extend from the first slope 531 toward the cover 200.

The first trapping surface 532 according to the present embodiment may extend from the end of the first slope 531 that extends toward the flange 422 toward one surface of the second cover body 220. The first trapping surface 532 may be disposed in parallel to the first direction. That is, the first trapping surface 532 may be disposed perpendicularly to one surface of the second cover body 220.

The second wedge part 540 may protrude from the ring gear 420 toward the cover 200 in the first direction.

The second wedge part 540 may be provided in a plural number. The number of plurality of second wedge parts 540 may be the same as the number of plurality of first wedge parts 530. The plurality of second wedge parts 540 may be arranged at predetermined intervals in a circumferential direction thereof centering around the central axis of the ring gear 420. The second wedge parts 540 may come into contact with different first wedge parts 530 in a process of assembling the cover 200 and the ring gear 420.

The first wedge part 530 according to the present embodiment may include a second slope 541 and a second trapping surface 542.

The second slope 541 is inclined with respect to the first direction, and may be disposed in parallel to the first slope 531.

The second slope 541 according to the present embodiment may slantly extend at a predetermined angle to the first direction from one surface (i.e., an upper surface on the basis of FIGS. 6 and 9) of the flange 422 that faces one surface of the second cover body 220 in the first direction. FIGS. 6 and 9 illustrate an example in which the second slope 541 extends in a direction in which the second slope 541 protrudes toward the second cover body 220 as the second slope 541 is more directed toward the left or counterclockwise direction, but the direction in which the second slope 541 extends is not limited thereto and may be variously designed and changed depending on the direction in which the first slope 531 extends.

The second slope 541 may be disposed in parallel to the first slope 531. When the guide pin 520 is disposed within the second guide rail 512, the second slope 541 may come into contact with the first slope 531.

The second trapping surface 542 may extend from the second slope 541 toward the ring gear 420.

The second trapping surface 542 according to the present embodiment may extend from the end of the second slope 541 that extends toward the second cover body 220 toward one surface of the flange 422. The second trapping surface 542 may be disposed in parallel to the first direction. That is, the second trapping surface 542 may be disposed perpendicularly to one surface of the flange 422.

When the guide pin 520 is moved in the direction opposite to the second direction within the second guide rail 512, the second trapping surface 542 may come into contact with the first trapping surface 532. In this case, as the first trapping surface 532 and the second trapping surface 542 are disposed in parallel to the first direction, the first trapping surface 532 and the second trapping surface 542 may restrict a movement of the guide pin 520 in the second direction.

The first wedge part 530 and the second wedge part 540 may be provided to be elastically deformable. For example, the first wedge part 530 and the second wedge part 540 may each be made of a material that is elastically deformable, such as plastic. Accordingly, when the first slope 531 and the second slope 541 come into contact with each other, the first wedge part 530 and the second wedge part 540 may enable a movement of the guide pin 520 in the second direction to be performed more smoothly by their elastic deformation.

The second wedge part 540 according to the present embodiment may further include a groove 543.

The groove 543 according to the present embodiment may have a form of a groove that is concavely formed from the second trapping surface 542 to the inside of the second wedge part 540. A direction in which the groove 543 extends is not limited to the direction illustrated in FIG. 9, and may be variously designed and changed within the range of a direction that intersects the first direction. Accordingly, the groove 543 may enable the compression and deformation of the second wedge part 540 to be performed more smoothly when the first slope 531 and the second slope 541 come into contact with each other.

The SFA 40 according to the present embodiment may further include a control member 600.

The control member 600 may function as a component that generally controls an operation of the motor 300.

The control member 600 according to the present embodiment may include a control housing 610 and a control module 620.

The control housing 610 according to the present embodiment may have a form of a container having an inside emptied and one side opened. The opened side of the control housing 610 may be disposed toward the first accommodation part 120. The control housing 610 may come into contact with the end of the housing body 110 that is disposed to surround the first accommodation part 120. The control housing 610 may be integrally formed with the housing body 110 or may be coupled with the housing body 110 by welding or bolting.

The control module 620 is disposed within the control housing 610, and may be connected to the motor 300. The control module 620 may control an operation of the motor 300 based on data that are detected by the steering output sensor. The control module 620 may be constructed to include at least any one of an electronic control unit (ECU), a central processing unit (CPU), a processor, or a system on chip (SoC), may control a plurality of hardware or software components by driving an operating system or an application, and may perform various types of data processing and operations. The control module 620 may be constructed to execute at least one instruction stored in memory and to store the result data of the execution in the memory. The control module 620 may be constructed to include at least any one of radio frequency (RF), wireless fidelity (Wi-Fi), Bluetooth, Zigbee, and near field communication (NFC) devices which can receive data detected by the steering output sensor and an input signal that is generated by a driver's terminal or various input devices and in which various communication protocols can be implemented.

Hereinafter, a process of assembling the SFA 40 according to an embodiment of the present disclosure is described.

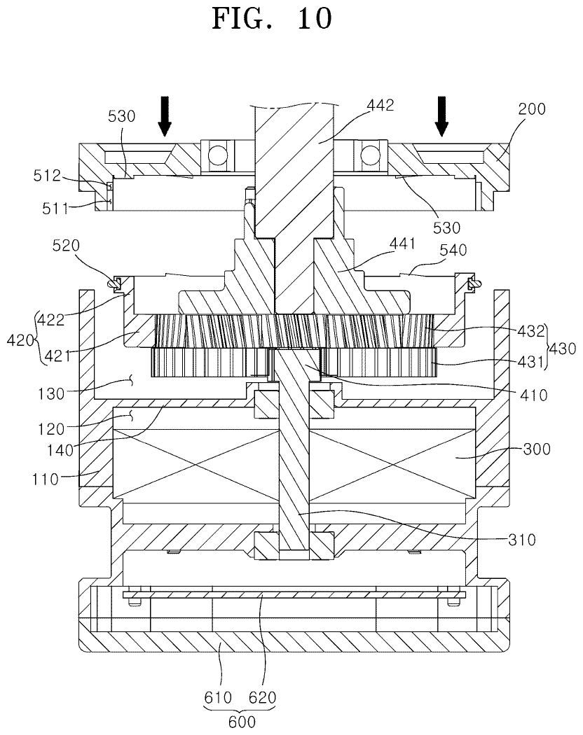

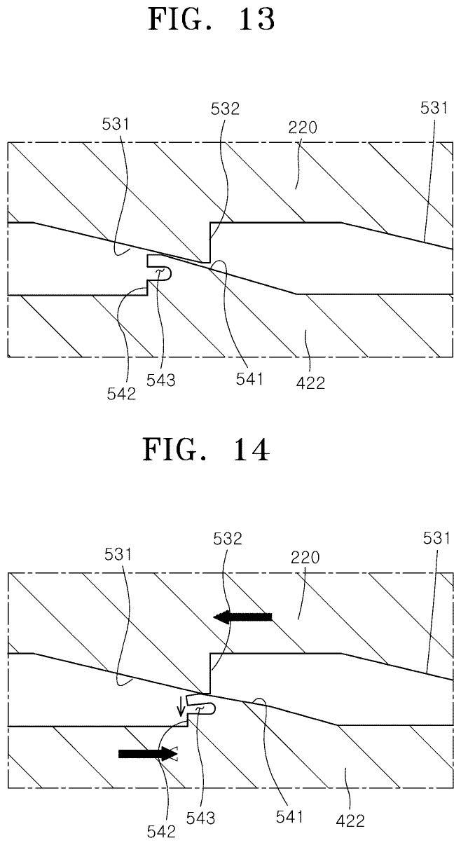

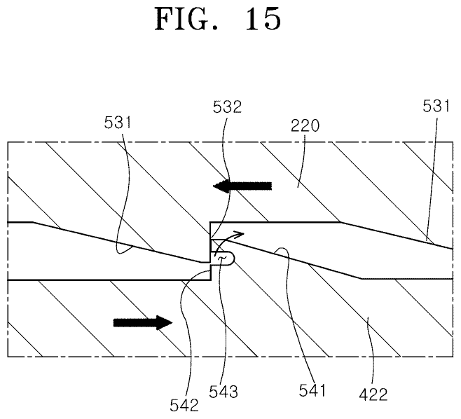

FIGS. 10 to 15 are diagrams schematically illustrating a process of assembling the SFA according to an embodiment of the present disclosure.

Referring to FIG. 10, the cover 200 may be moved toward the ring gear 420 in the direction opposite to the first direction in the state in which the motor 300 and the deceleration member 400 have been installed within the housing 100. FIG. 10 illustrates an example in which the cover 200 is moved toward the ring gear 420 in the direction opposite to the first direction, but the present disclosure is not limited thereto. The ring gear 420 may be moved toward the cover 200 in the first direction.

Referring to FIG. 11, as the cover 200 is moved toward the ring gear 420 at a set distance or more, the protrusion part 522 is inserted into the first guide rail 511.

As the protrusion part 522 is moved along the first guide rail 511 in the first direction, the cover 200 continues to be moved in the direction opposite to the first direction, and the interval between the cover 200 and the ring gear 420 is reduced.

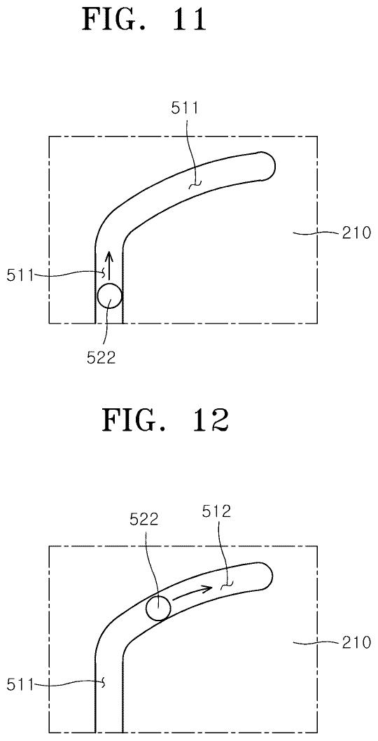

Referring to FIG. 12, as any one of the cover 200 or the ring gear 420 is relatively rotated with respect to the other of the cover 200 or the ring gear 420 centering around the central axis of the housing body 110 in the state in which the protrusion part 522 has been disposed at the end of the first guide rail 511, the protrusion part 522 is moved along the second guide rail 512 in the second direction.

As the protrusion part 522 is moved along the second guide rail 512 in the second direction, the cover 200 is relatively rotated with respect to the ring gear 420 and continues to be moved in the direction opposite to the first direction, and the interval between the cover 200 and the ring gear 420 is reduced.

Referring to FIGS. 13 to 15, when the protrusion part 522 is disposed within the second guide rail 512, the first slope 531 comes into contact with the second slope 541.

As the protrusion part 522 is moved along the second guide rail 512 in the second direction, the first slope 531 and the second slope 541 are moved in opposite directions in the state in which the first slope 531 and the second slope 541 come into contact with each other.

The first wedge part 530 and the second wedge part 540 are compressed and deformed by a compression force that is applied in a direction perpendicular to the first slope 531 and the second slope 541.

Accordingly, the first slope 531 and the second slope 541 may be relatively moved with respect to each other without increasing the interval between the cover 200 and the ring gear 420 in a process of the protrusion part 522 being moved along the second guide rail 512 in the second direction.

As the protrusion part 522 is moved along the second guide rail 512 at a predetermined interval or more in the second direction, the first slope 531 and the second slope 541 are separated from each other.

Such an operation is repeatedly performed up to timing at which the support part 230 comes into contact with the end of the housing body 110 that is disposed to surround the second accommodation part 130.

As the first slope 531 and the second slope 541 are separated from each other, the first trapping surface 532 and the second trapping surface 542 are disposed to face each other in a direction perpendicular to the first direction.

In such a state, when the protrusion part 522 is moved along the second guide rail 512 in the direction opposite to the second direction, the first trapping surface 532 and the second trapping surface 542 come into contact with each other and restrict the movement of the protrusion part 522 in the direction opposite to the second direction. Accordingly, the cover 200 and the ring gear 420 may be maintained in the state in which the cover 200 and the ring gear 420 have been mutually fastened.

Hereinafter, the SFA 40 according to another embodiment of the present disclosure is described.

The SFA 40 according to the present embodiment may be constructed by making different only detailed components of the fixing member 500, compared to the SFA 40 according to an embodiment of the present disclosure, which has been described with reference to FIGS. 1 to 15.

Accordingly, in describing the SFA 40 according to the present embodiment, only the detailed components of the fixing member 500 compared to the SFA 40 according to an embodiment of the present disclosure are described.

The description of the SFA 40 according to an embodiment of the present disclosure may be applied to the remaining components of the SFA 40 according to the present embodiment without any change.

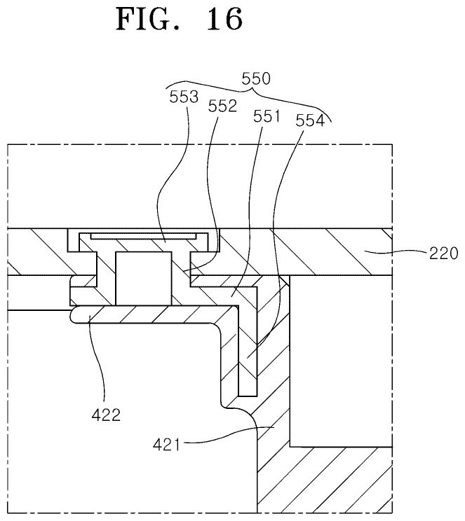

FIG. 16 is a diagram schematically illustrating a construction of a fixing member according to another embodiment of the present disclosure.

Referring to FIG. 16, the fixing member 500 according to the present embodiment may include a retainer 550.

The retainer 550 extends from the ring gear 420 toward the cover 200, and may be fixed to the cover 200. The retainer 550 may be made of a material different from that of the ring gear 420. For example, the retainer 550 may be made of a metal material, such as steel. The retainer 550 may be integrally fabricated with the ring gear 420 by insert injection.

The retainer 550 may be provided in a plural number. The plurality of retainers 550 may be arranged at predetermined intervals on a circumference centered around the central axis of the ring gear 420 between the ring gear 420 and the cover 200.

The retainer 550 according to the present embodiment includes a retainer body 551, an extension part 552, and a caulking part 553.

The retainer body 551 is fixed within the ring gear 420, and generally supports the extension part 552 and the caulking part 553.

The retainer body 551 according to the present embodiment may be formed to have a hollow-shaped ring shape. The retainer body 551 may be disposed within the flange 422. The central axis of the retainer body 551 may be disposed on the same axis as the central axis of the flange 422.

The extension part 552 extends from the retainer body 551, and may penetrate the cover 200.

The extension part 552 according to the present embodiment may have a form of a pillar that extends in the first direction from the retainer body 551 toward the cover 200. The extension part 552 may protrude from one surface of the flange 422 that faces the second cover body 220 of the cover 200. The extension part 552 may penetrate the second cover body 220 in the first direction. To this end, a through hole into which the extension part 552 is inserted may be formed in the second cover body 220.

The caulking part 553 is disposed at the end of the extension part 552, and may support the ring gear 420 with respect to the cover 200.

The caulking part 553 according to the present embodiment may be disposed at the end of the extension part 552 that penetrates the second cover body 220 in the first direction. The cross sectional area of the caulking part 553 may be greater than the cross sectional area of the extension part 552. The caulking part 553 may be disposed to face the retainer body 551 with the second cover body 220 interposed therebetween. Accordingly, the caulking part 553 is trapped and coupled with the lateral surface of the second cover body 220, and may restrict the cover 200 and the ring gear 420 from being relatively moved in the direction parallel to the first direction. The caulking part 553 may be integrally formed with the extension part 552. In another embodiment, the caulking part 553 may be coupled with the extension part 552 after manufactured separately from the extension part 552.

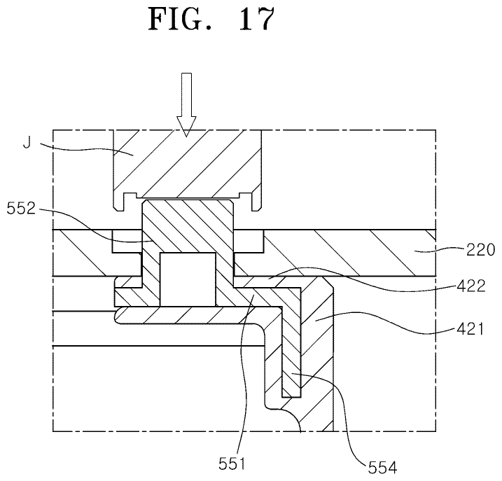

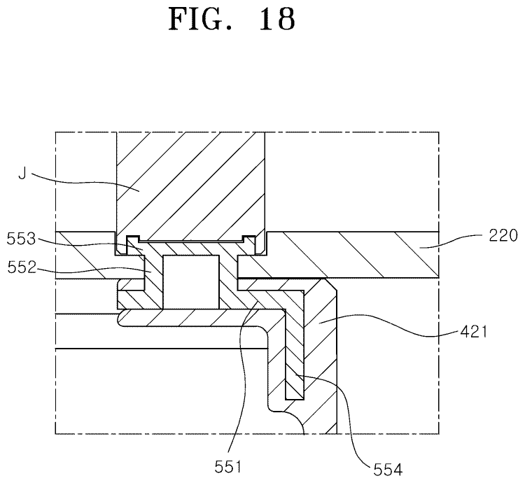

FIGS. 17 and 18 are diagrams schematically illustrating a process of forming a caulking part according to the present embodiment.

Referring to FIGS. 16 to 18, the caulking part 553 according to the present embodiment may be formed to have the same cross sectional area as the extension part 552 in its initial state. As the cover 200 is moved toward the ring gear 420 in the direction opposite to the first direction, the caulking part 553 may penetrate the second cover body 220 along with the extension part 552.

Thereafter, the caulking part 553 may be pressurized in the first direction by pressurization means J, such as a press.

The cross sectional area of the caulking part 553 is increased by a pressing force that is applied by the pressurization means J. The caulking part 553 may be trapped and coupled with the lateral surface of the second cover body 220.

The retainer 550 according to the present embodiment may further include a reinforcement part 554.

The reinforcement part 554 may function as a component that is connected to the retainer body 551 and that reinforces a coupling force between the retainer 550 and the ring gear 420.

The reinforcement part 554 according to the present embodiment may extend from the retainer body 551 toward the ring gear body 421. The reinforcement part 554 may have a form of a cylinder having a central axis disposed on the same axis as the central axis of the ring gear body 421. A length in which the reinforcement part 554 extends may be variously designed and changed depending on the length of the ring gear body 421 that is parallel to the first direction.

The present disclosure has been described with reference to the embodiments illustrated in the drawings, but this is merely exemplary. It should be understood that various modifications and other equivalent embodiments are possible based on common knowledge in the art to which a corresponding technology pertains.

Accordingly, the true technical range of protection of the present disclosure is based on the claims to be described hereinafter and should be determined based on the aforementioned detailed contents of the present disclosure.

What is claimed is:

1. A steering feedback actuator comprising:
a housing;
a cover disposed to face the housing;
a motor disposed within the housing;
a sun gear connected to the motor;
a ring gear disposed to surround the sun gear;
a planet gear disposed between the sun gear and the ring gear;
a carrier connected to the planet gear and rotated in conjunction with a rotation of the planet gear; and
a fixing member provided between the cover and the ring gear and configured to fix the cover to the ring gear.

2. The steering feedback actuator of claim 1, wherein the housing comprises:
a housing body;
a first accommodation part disposed within the housing body and configured to accommodate the motor;
a second accommodation part disposed between the first accommodation part and the cover and configured to accommodate the ring gear; and
a barrier rib disposed between the first accommodation part and the second accommodation part.

3. The steering feedback actuator of claim 1, wherein the planet gear comprises:
a first planet gear body configured to engage with the sun gear; and
a second planet gear body configured to extend from the first planet gear body and engaged with the ring gear.

4. The steering feedback actuator of claim 3, wherein a diameter of the second planet gear body is smaller than a diameter of the first planet gear body.

5. The steering feedback actuator of claim 1, wherein the carrier comprises:
a carrier body disposed to face the planet gear and configured to penetrate the cover; and
a transfer shaft coupled with the carrier body and configured to extend to an outside of the cover.

6. The steering feedback actuator of claim 1, wherein the fixing member comprises:
a guide rail concavely formed into an inside surface of one of the cover and the ring gear; and
a guide pin configured to protrude from the corresponding other surface of the cover and the ring gear and inserted into the guide rail.

7. The steering feedback actuator of claim 6, wherein:
the cover and the ring gear are disposed to face each other in a first direction, and
the guide rail comprises:
a first guide rail configured to extend in the first direction; and
a second guide rail configured to extend in a second direction that intersects the first direction.

8. The steering feedback actuator of claim 7, wherein an interval between the cover and the ring gear is reduced as the guide pin moves from the first guide rail toward the second guide rail.

9. The steering feedback actuator of claim 7, wherein the fixing member further comprises:
a first wedge part protruding from the cover toward the ring gear; and
a second wedge part protruding from the ring gear toward the cover, the second wedge part configured to come into contact with the first wedge part, and to restrict the guide pin from being moved in a direction opposite to the second direction.

10. The steering feedback actuator of claim 9, wherein the first wedge part and the second wedge part are elastically deformable.

11. The steering feedback actuator of claim 9, wherein:
the first wedge part is provided in a plural number, and
arranged in a circumferential direction centered around a central axis of the cover.

12. The steering feedback actuator of claim 9, wherein the first wedge part comprises:
a first slope disposed to be inclined with respect to the first direction; and
a first trapping surface configured to extend from the first slope toward the cover and disposed in parallel to the first direction, and
wherein the second wedge part comprises:
a second slope disposed in parallel to the first slope and configured to come into contact with the first slope; and
a second trapping surface configured to extend from the second slope toward the ring gear and disposed in parallel to the first direction.

13. The steering feedback actuator of claim 12, wherein the second wedge part further comprises a groove concavely formed from the second trapping surface.

14. The steering feedback actuator of claim 1, wherein the fixing member comprises:
a retainer body fixed within the ring gear;
an extension part configured to extend from the retainer body and to penetrate the cover; and
a caulking part disposed at an end of the extension part and configured to support the ring gear with respect to the cover.

15. The steering feedback actuator of claim 14, wherein a cross sectional area of the caulking part is greater than a cross sectional area of the extension part.
